(19) United States
(12) Patent Application Publication
(10) Pub. No.: US 2022/0385008 A1
(43) Pub. Date: Dec. 1, 2022

(54) MULTIPLE COAXIAL CONNECTOR

(71) Applicant: HOSIDEN CORPORATION, Osaka (JP)

(72) Inventor: Yuta IWAMOTO, Osaka (JP)

(73) Assignee: HOSIDEN CORPORATION, Osaka (JP)

(21) Appl. No.: 17/752,397

(22) Filed: May 24, 2022

(30) Foreign Application Priority Data
May 31, 2021 (JP) 2021-091012

(51) Int. Cl. H01R 24/50; H01R 13/6581; H01R 25/00

(52) U.S. Cl. CPC H01R 24/50; H01R 13/6581; H01R 25/006

(57) ABSTRACT

A multiple coaxial connector includes a contact pair that is composed of a first contact and a second contact, a body that accommodates each contact, a shell that accommodates the body, a shield cover that covers a portion of the shell, and a board mounting portion. The first contact includes a first main body portion that is extended in a first direction, a first contact portion that is formed on one end of the first main body portion and is to be brought into contact with a contact of the mating multiple coaxial connector, and a first leading portion that is extended from the other end of the first main body portion in a direction that is orthogonal to the first direction and directs toward a second direction. A plurality of the contact pairs are arranged in a third direction.

### TECHNICAL FIELD

The present invention relates to a multiple coaxial connector.

### BACKGROUND ART

For example, Japanese Patent Application Laid Open No. 2021-051925 is disclosed as a conventional example of a multiple coaxial connector that connects a plurality of coaxial cables with each other.

Multiple coaxial connectors of related art are easily affected by a signal flowing between mutually-adjacent contacts (crosstalk easily occurs) because the contacts are close to each other and the contacts cannot be completely shielded from each other.

Conventional communication bands are at most approximately 4 GHz and accordingly, communication has been possible without taking into account crosstalk. However, crosstalk becomes noticeable in a communication band up to 10 GHz band which will be realized in near future and communication may become impossible unless a countermeasure to reduce crosstalk is taken.

### SUMMARY OF THE INVENTION

An object of the present invention is to provide a multiple coaxial connector that is capable of reducing an influence of crosstalk.

A multiple coaxial connector according to the present invention includes a contact pair that is composed of a first contact and a second contact, a body that accommodates each contact, a shell that accommodates the body, a shield cover that covers a portion of the shell, and a board mounting portion.

The first contact includes a first main body portion that is extended in an insertion direction of a mating multiple coaxial connector (hereinafter, referred to as a first direction), a first contact portion that is formed on one end of the first main body portion and is to be brought into contact with a contact of the mating multiple coaxial connector, and a first leading portion that is extended from the other end of the first main body portion in a direction that is orthogonal to the first direction and directs toward a board on which the multiple coaxial connector is mounted (hereinafter, referred to as a second direction).

A plurality of the contact pairs are arranged in a direction that is orthogonal to the first direction and the second direction (hereinafter, referred to as a third direction).

The board mounting portion is formed on a board mounting surface of the shell in a manner to be positioned between adjacent first leading portions.

### EFFECTS OF THE INVENTION

According to the multiple coaxial connector of the present invention, an influence of crosstalk can be reduced.

### BRIEF DESCRIPTION OF THE DRAWINGS

FIG. 1 is a front elevational view illustrating a multiple coaxial connector according to a first embodiment.

FIG. 2 is a perspective view illustrating a front surface, a right side surface, and an upper surface of the multiple coaxial connector according to the first embodiment.

FIG. 3 is a perspective view illustrating a back surface, the right side surface, and a bottom surface of the multiple coaxial connector according to the first embodiment.

FIG. 4 is a sectional view illustrating the multiple coaxial connector according to the first embodiment.

FIG. 5 is a graph showing a simulation result of a value of crosstalk from a second contact of one contact pair to a first contact of the other contact pair in a case where a third contact point is provided and a simulation result of a value of crosstalk between the same contacts in a case where the third contact point is not provided.

FIG. 6 is a graph showing a simulation result of a value of crosstalk from a second contact of one contact pair to a second contact of the other contact pair in a case where a fifth contact point is provided and a simulation result of a value of crosstalk between the same contacts in a case where the fifth contact point is not provided.

FIG. 7 is a graph showing a simulation result of a value of crosstalk from a first contact of one contact pair to a first contact of the other contact pair in a case where a first board mounting portion is provided and a simulation result of a value of crosstalk between the same contacts in a case where the first board mounting portion is not provided.

FIG. 8 is a graph showing a simulation result of a value of crosstalk from a second contact of one contact pair to a second contact of the other contact pair in a case where a second board mounting portion is provided and a simulation result of a value of crosstalk between the same contacts in a case where the second board mounting portion is not provided.

### DETAILED DESCRIPTION

An embodiment according to the present invention will be described in detail below. Here, components mutually having the same functions will be provided with the same reference numerals and the duplicate description thereof will be omitted.

### First Embodiment

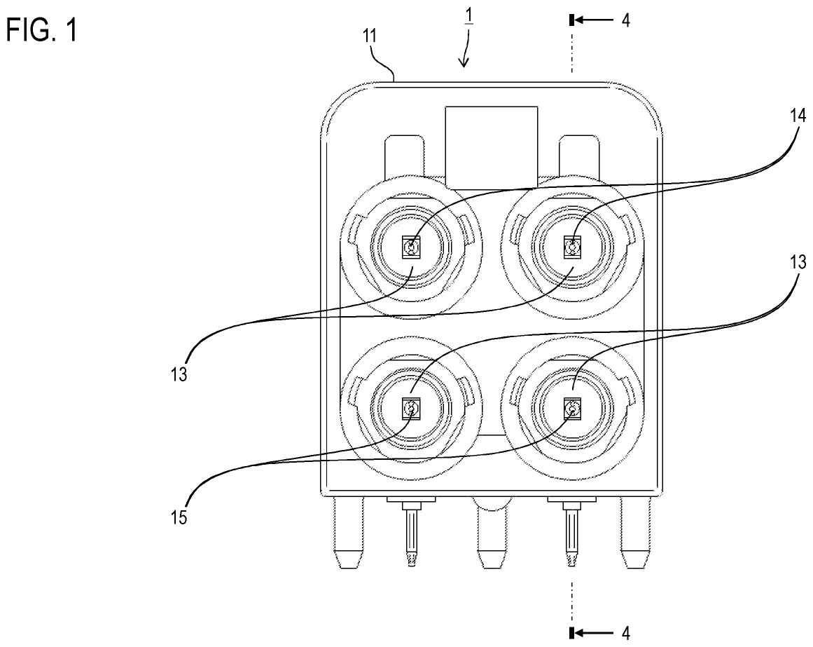

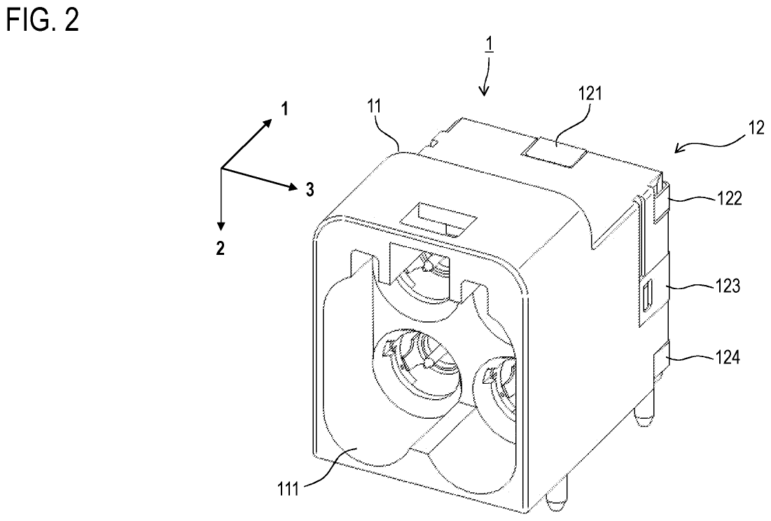

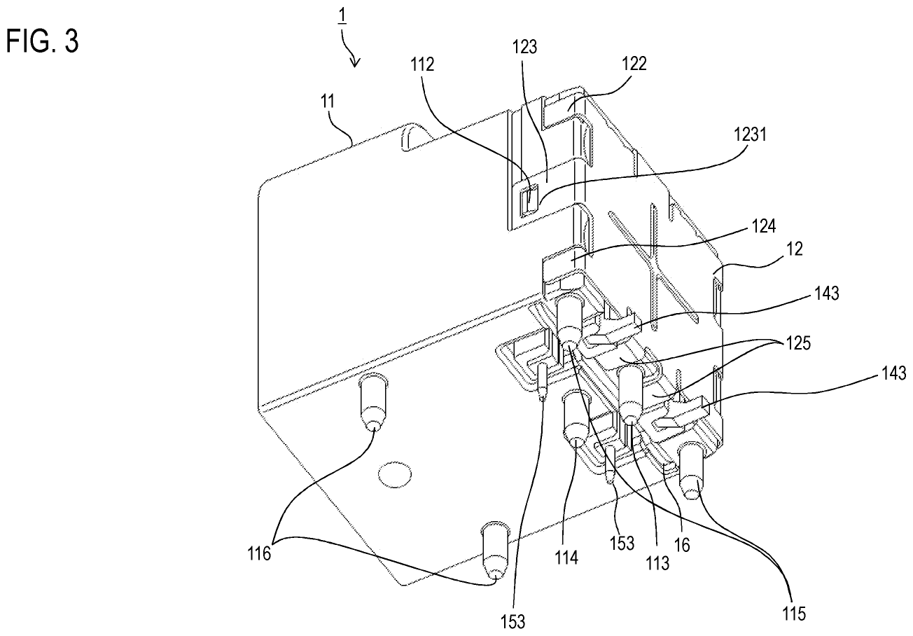

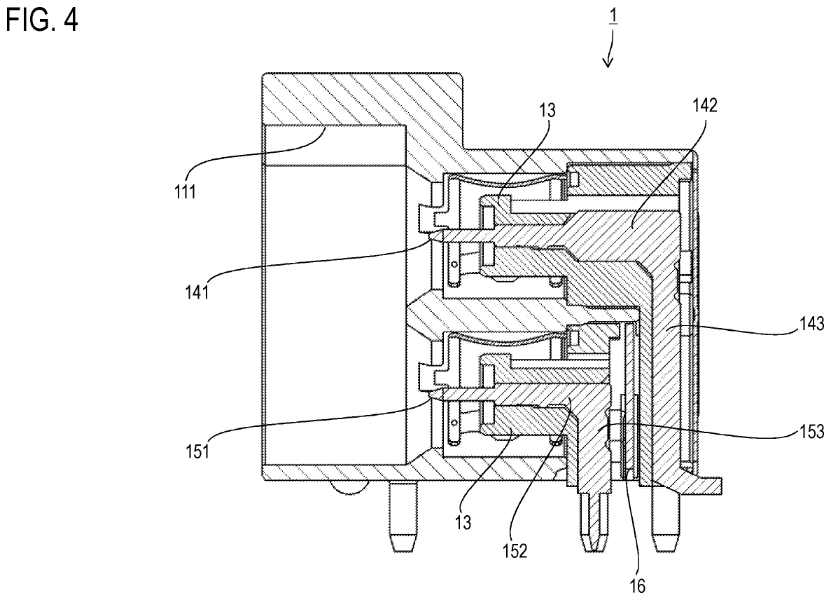

A configuration of a multiple coaxial connector 1 (receptacle type) according to a first embodiment will be described with reference to FIGS. 1 to 4. The multiple coaxial connector 1 according to the present embodiment includes a contact pair composed of a first contact 14 and a second contact 15, a body 13 accommodating each contact, a shell 11 (see FIG. 1) accommodating the body 13, a shield cover 12 (see FIGS. 2 and 3) covering a portion of the shell 11, a first board mounting portion 113, a second board mounting portion 114, two pieces of third board mounting portions 115, two pieces of fourth board mounting portions 116, and a shield plate 16 provided in the inside of the shell 11 (see FIGS. 3 and 4). The first to fourth board mounting portions 113 to 116 are provided on a board mounting surface of the shell 11.

An accommodation portion 111 is formed on the front surface of the shell 11 (see FIG. 2). A shell of a mating multiple coaxial connector (plug type) is inserted into this accommodation portion 111. On a right side surface and a left side surface of the shell 11, respective claws 112 are formed (see FIG. 3).

As illustrated in FIG. 4, the first contact 14 includes a first main body portion 142, a first contact portion 141, and a first leading portion 143. The first main body portion 142 is extended in an insertion direction of a mating multiple coaxial connector (hereinafter, referred to as a first direction, which is denoted as “1” in bold typeface in FIG. 2 and corresponds to an arrow direction corresponding to “1”). The first contact portion 141 is formed on one end of the first main body portion 142 and is to be brought into contact with a contact of the mating multiple coaxial connector. The first leading portion 143 is extended from the other end of the first main body portion 142 in a direction that is orthogonal to the first direction and directs toward a board on which the present connector is mounted (hereinafter, referred to as a second direction, which is denoted as “2” in bold typeface in FIG. 2 and corresponds to an arrow direction corresponding to “2”).

The second contact 15 includes a second main body portion 152, a second contact portion 151, and a second leading portion 153 as illustrated in FIG. 4. The second main body portion 152 is extended in the first direction and is positioned farther in the second direction than the first main body portion 142. The second contact portion 151 is formed on one end of the second main body portion 152 and is to be brought into contact with a contact of the mating multiple coaxial connector. The second leading portion 153 is extended from the other end of the second main body portion 152 in the second direction and is positioned in an opposite direction of the first direction relative to the first leading portion 143.

A plurality of contact pairs are arranged in a direction that is orthogonal to the first direction and the second direction (hereinafter, referred to as a third direction, which is denoted as “3” in bold typeface in FIG. 2 and corresponds to an arrow direction corresponding to “3” or an opposite direction of the arrow direction).

The body 13 is inserted into the shell 11 from the opposite direction of the first direction. The shield cover 12 is formed to lid the shell 11 and the body 13 from the opposite direction of the first direction (see FIG. 3).

The first board mounting portion 113 is formed on the board mounting surface of the shell 11 in a manner to be positioned between adjacent first leading portions 143.

The second board mounting portion 114 is formed on the board mounting surface of the shell 11 in a manner to be positioned between adjacent second leading portions 153, as illustrated in FIG. 3.

The third board mounting portion 115 is formed on the board mounting surface of the shell 11 in a manner to be symmetry to the first board mounting portion 113 centering on the first leading portion 143, as illustrated in FIG. 3.

The fourth board mounting portion 116 is formed on the board mounting surface of the shell 11 in the opposite direction to the first direction relative to the third board mounting portion 115, as illustrated in FIG. 3.

The first board mounting portion 113 and the second board mounting portion 114 are terminal type mounting portions that protrude in the second direction, as illustrated in FIG. 3 (the type may be substituted for another type, which will be described later).

The shield plate 16 is positioned between the first leading portion 143 and the second leading portion 153 and is electrically connected with the shell 11, as illustrated in FIGS. 3 and 4.

The shield cover 12 includes a plurality of contact points that are in contact with surfaces adjacent to the lidded surface of the shell 11 and are fixed on the surfaces of the shell 11 by an elastic force, as illustrated in FIGS. 2 and 3. In the present embodiment, the shield cover 12 is configured to include a first contact point 121, a second contact point 122, a third contact point 123, a fourth contact point 124, and two fifth contact points 125. The first contact point 121 is in contact with the upper surface of the shell 11. The second contact point 122 is in contact with an upper portion of the side surface of the shell 11. The third contact point 123 is in contact with an intermediate portion of the side surface of the shell 11 and includes a hole 1231 which is engaged with the claw 112. The fourth contact point 124 is in contact with a lower portion of the side surface of the shell 11. The fifth contact points 125 are in contact with the bottom surface of the shell 11.

The fifth contact point 125 is positioned between the first leading portion 143 and the first board mounting portion 113, as illustrated in FIG. 3.

### <Verification of Crosstalk Reduction Effect Based on Simulation>

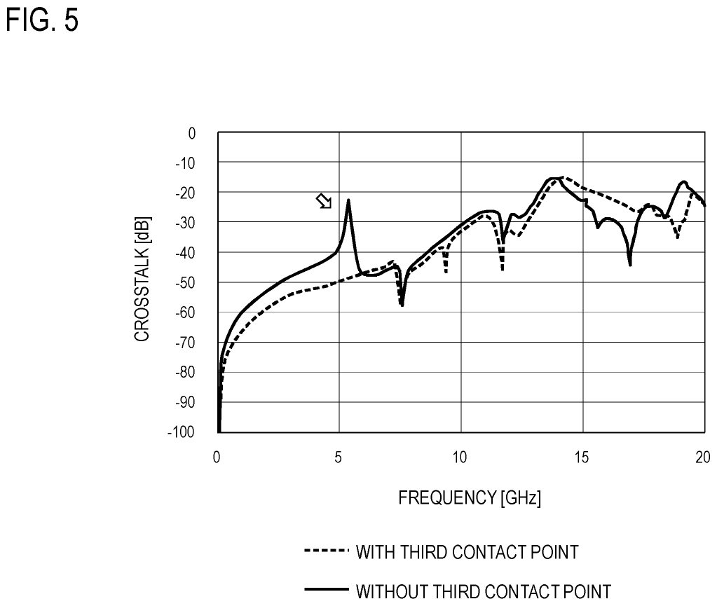

FIGS. 5 to 8 illustrate verification results of the crosstalk reduction effect obtained through simulation. As illustrated in a graph of FIG. 5, when comparing a case where the third contact point 123 is provided (dashed line graph) and a case where the third contact point 123 is not provided (solid line graph) with each other, the solid line graph shows an occurrence of characteristic disturbance illustrated with a white arrow. In addition to this, it can be seen that crosstalk from the second contact 15 of one contact pair to the first contact 14 of the other contact pair is smaller in the simulation result of the case where the third contact point 123 is provided than the simulation result of the case where the third contact point 123 is not provided.

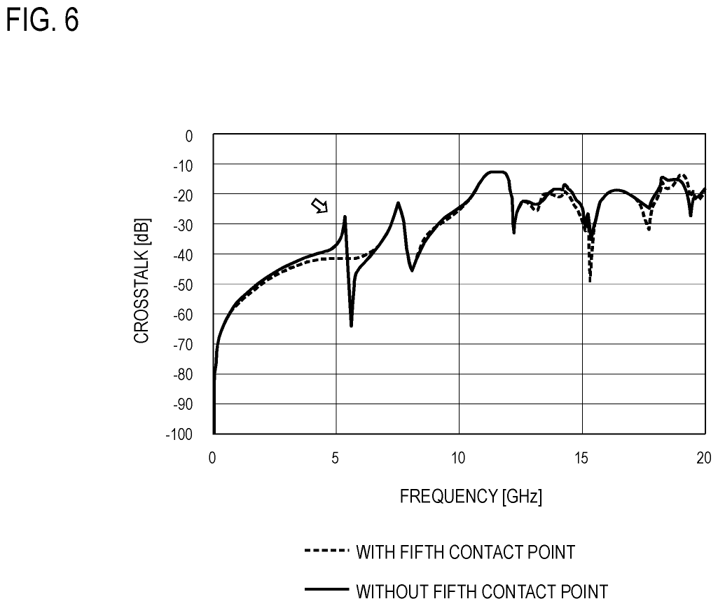

As illustrated in a graph of FIG. 6, when comparing a case where the fifth contact point 125 is provided (dashed line graph) and a case where the fifth contact point 125 is not provided (solid line graph) with each other, the solid line graph shows an occurrence of characteristic disturbance illustrated with a white arrow. In addition to this, it can be seen that crosstalk from the second contact 15 of one contact pair to the second contact 15 of the other contact pair is smaller in the simulation result of the case where the fifth contact point 125 is provided than the simulation result of the case where the fifth contact point 125 is not provided.

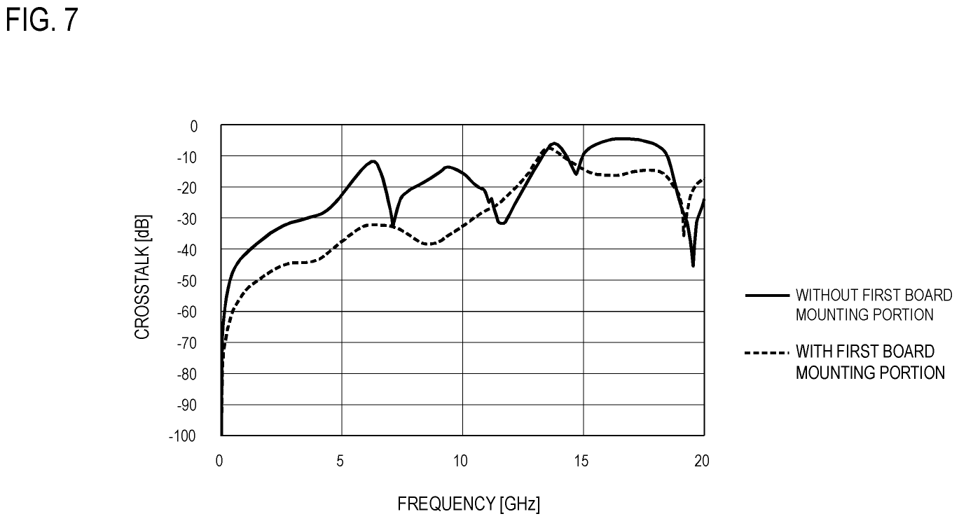

As illustrated in a graph of FIG. 7, when comparing a case where the first board mounting portion 113 is provided (dashed line graph) and a case where the first board mounting portion 113 is not provided (solid line graph) with each other, it can be seen that crosstalk from the first contact 14 of one contact pair to the first contact 14 of the other contact pair is smaller in the simulation result of the case where the first board mounting portion 113 is provided than the simulation result of the case where the first board mounting portion 113 is not provided.

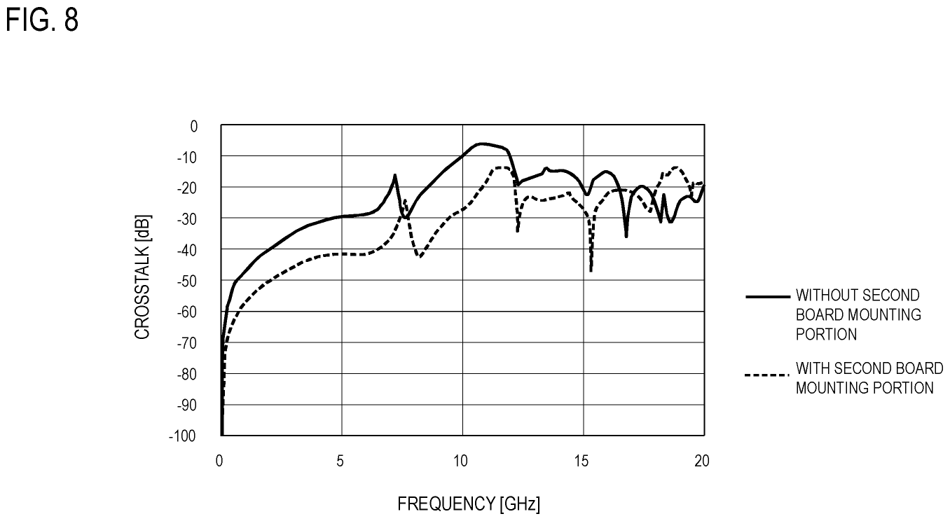

As illustrated in a graph of FIG. 8, when comparing a case where the second board mounting portion 114 is provided (dashed line graph) and a case where the second board mounting portion 114 is not provided (solid line graph) with each other, it can be seen that crosstalk from the second contact 15 of one contact pair to the second contact 15 of the other contact pair is smaller in the simulation result of the case where the second board mounting portion 114 is provided than the simulation result of the case where the second board mounting portion 114 is not provided.

<First Modification>

The first, second, third, and fourth board mounting portions 113 to 116 are of a through hole type in the above-described embodiment. However, a similar crosstalk reduction effect can be obtained even though these board mounting portions are of a surface mounting type. The shape of the board mounting portions can be selected from the through hole type, the surface mounting type, and the like depending on connector design. Advantageous effects to be obtained from respective types will be described later.

<Second Modification>Similar advantageous effects can be obtained when three or more contact pairs are arranged in the third direction and board mounting portions are provided between respective pairs of leading portions.

Advantageous effects obtained from respective components of the multiple coaxial connector 1 according to the present embodiment will be briefly described below.

<Advantageous Effect: First to Fourth Board Mounting Portions 113 to 116>

GND paths connecting the multiple coaxial connector 1 of the present embodiment with a board pattern are formed between contacts aligning in the third direction, producing a GSGSG (G: GND, S: signal) array. Accordingly, crosstalk between the contacts can be reduced (see FIGS. 7 and 8 for simulation results).

Further, an electrical length of a signal channel connecting the contact with the board pattern and an electrical length of a GND channel connecting the shell with the board pattern are substantially the same as each other, improving EMC resistance as well. Also, the number of GND-board connection points is increased near the leading portions and the number of channels for return current is increased, improving transmission performance.

The third board mounting portions 115 and the fourth board mounting portions 116 are arranged on the board mounting surface of the shell 11 in a well-balanced manner, being able to improve positioning and mounting strength in board mounting of the multiple coaxial connector 1. Accordingly, as long as the fourth board mounting portions 116 are arranged to have a well-balanced positional relation with the third board mounting portions 115 on the board mounting surface of the shell 11, the positions and the numbers of the fourth board mounting portions 116 are not limited to those of the present embodiment.

<Advantageous Effect: Shield Plate 16>

The shell 11 does not exist between respective leading portions of the first contact 14 and the second contact 15. When an electrical shield is not arranged between the leading portions, an influence of crosstalk is increased unless the first contact 14 and the second contact 15 are arranged with enough distance in between in the first direction. If an enough distance is provided in the first direction, however, the length of the multiple coaxial connector 1 is increased in the first direction and a board occupation area is increased.

In the present embodiment, the shield plate 16 is incorporated in a manner to be electrically connected with the shell 11 and respective leading portions of the first contact 14 and the second contact 15 are thus shielded by the member having a GND potential. Accordingly, crosstalk between the first contact 14 and the second contact 15 can be reduced without enlarging the outer shape of the multiple coaxial connector 1.

In terms of the leading portion, the provision of the GND member on the same axis improves the EMC characteristics and the substantially coaxial shape facilitates impedance control, easily improving a signal quality.

<Advantageous Effect: First to Fourth Board Mounting Portions 113 to 116=Through Hole Type>

When the first to fourth board mounting portions 113 to 116 are of the through hole type, the length of the GND path connecting respective GND patterns of the mounting surface, back surface, and inner layer can be shortened. This can prevent deterioration of the EMC characteristics caused by sneak or loop of GND noise and improve positioning and mounting strength in board mounting of the multiple coaxial connector 1.

<Advantageous Effect: First to Fourth Board Mounting Portions 113 to 116=Surface Mounting Type>

When the first to fourth board mounting portions 113 to 116 are of the surface mounting type and a board pattern is introduced to the back surface and an inner layer pattern with via holes directly under or near the board mounting portion, the length of the GND path connecting respective GND patterns of the mounting surface, back surface, and inner layer can be shortened. This can prevent deterioration of the EMC characteristics caused by sneak or loop of GND noise. Also, there is no through holes, making it possible to introduce wiring to a corresponding portion of the back surface and inner layer and to mount components on the back surface.

<Advantageous Effect: First to Fifth Contact Points 121 to 125>

The provision of the first to fifth contact points 121 to 125 to the shield cover 12 can suppress characteristic disturbance and reduce crosstalk (see FIGS. 5 and 6 for simulation results).

Especially in terms of the second to fourth contact points 122 to 124, the existence of the contact points on the side surfaces of the shell 11 reinforces the GND path passing via the shell 11 and can reduce crosstalk occurring between each set of contacts such as between the second contact 15 of one contact pair and the first contact 14 of the other contact pair.

The foregoing description of the embodiment of the invention has been presented for the purpose of illustration and description. It is not intended to be exhaustive and to limit the invention to the precise form disclosed. Modifications or variations are possible in light of the above teaching. The embodiment was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A multiple coaxial connector comprising:
a contact pair that is composed of a first contact and a second contact;
a body that accommodates each contact;
a shell that accommodates the body;
a shield cover that covers a portion of the shell; and
a board mounting portion, wherein
the first contact includes
a first main body portion that is extended in an insertion direction of a mating multiple coaxial connector, the insertion direction being referred to as a first direction,
a first contact portion that is formed on one end of the first main body portion and is to be brought into contact with a contact of the mating multiple coaxial connector, and
a first leading portion that is extended from the other end of the first main body portion in a second direction that is orthogonal to the first direction and directs toward a board on which the multiple coaxial connector is mounted,
a plurality of the contact pairs are provided and the plurality of the contact pairs are arranged in a third direction that is orthogonal to the first direction and the second direction, and
a plurality of the first leading portions are provided and the board mounting portion is formed on a board mounting surface of the shell in a manner to be positioned between adjacent first leading portions of the plurality of the first leading portions.

2. The multiple coaxial connector according to claim 1, wherein
the second contact includes
a second main body portion that is extended in the first direction and is positioned farther in the second direction than the first main body portion,
a second contact portion that is formed on one end of the second main body portion and is to be brought into contact with a contact of the mating multiple coaxial connector, and
a second leading portion that is extended from the other end of the second main body portion in the second direction and is positioned in an opposite direction of the first direction relative to the first leading portion, and
a plurality of the second leading portions are provided and the multiple coaxial connector includes a second board mounting portion that is formed on the board mounting surface of the shell in a manner to be positioned between adjacent second leading portions of the plurality of the second leading portions.

3. The multiple coaxial connector according to claim 2, further comprising:
a shield plate that is positioned between the first leading portion and the second leading portion and is electrically connected with the shell.

4. The multiple coaxial connector according to claim 1, wherein
the body is inserted into the shell from the opposite direction of the first direction, and
the shield cover is formed to lid the shell and the body from the opposite direction of the first direction and includes a plurality of contact points that are in contact with a surface adjacent to a lidded surface of the shell and are fixed on the surface of the shell by an elastic force.

5. The multiple coaxial connector according to claim 2, wherein
the body is inserted into the shell from the opposite direction of the first direction, and
the shield cover is formed to lid the shell and the body from the opposite direction of the first direction and includes a plurality of contact points that are in contact with a surface adjacent to a lidded surface of the shell and are fixed on the surface of the shell by an elastic force.

6. The multiple coaxial connector according to claim 3, wherein
the body is inserted into the shell from the opposite direction of the first direction, and
the shield cover is formed to lid the shell and the body from the opposite direction of the first direction and includes a plurality of contact points that are in contact with a surface adjacent to a lidded surface of the shell and are fixed on the surface of the shell by an elastic force.

7. The multiple coaxial connector according to claim 4, wherein any one of the contact points is positioned between the first leading portion and the board mounting portion.

8. The multiple coaxial connector according to claim 5, wherein any one of the contact points is positioned between the first leading portion and the board mounting portion.

9. The multiple coaxial connector according to claim 6, wherein any one of the contact points is positioned between the first leading portion and the board mounting portion.

10. The multiple coaxial connector according to claim 4, wherein any one of the contact points is positioned on a side surface of the shell.

11. The multiple coaxial connector according to claim 5, wherein any one of the contact points is positioned on a side surface of the shell.

12. The multiple coaxial connector according to claim 6, wherein any one of the contact points is positioned on a side surface of the shell.

13. The multiple coaxial connector according to claim 1, wherein the board mounting portion is of a through hole type.

14. The multiple coaxial connector according to claim 1, wherein the board mounting portion is of a surface mounting type.
